(19) United States
(12) Patent Application Publication
(10) Pub. No.: US 2003/0060541 A1
(43) Pub. Date: Mar. 27, 2003

(54) Lead-free cationic electrodeposition coating composition, electrodeposition coating process, and process for forming double layered coated film

(76) Inventors: Yoshio Kojima, Nara-ken (JP); Mitsuo Yamada, Osaka-fu (JP); Satoru Uchidoi, Osaka-fu (JP)

Correspondence Address: WENDEROTH, LIND & PONACK, L.L.P., 2033 K STREET N. W., SUITE 800, WASHINGTON, DC, 20006-1021, US

(21) Appl. No.: 10/107,433

(22) Filed: Mar. 28, 2002

(30) Foreign Application Priority Data
Mar. 28, 2001 (JP) 2001-092687
Mar. 28, 2001 (JP) 2001-092688
Mar. 28, 2001 (JP) 2001-092691
Mar. 28, 2001 (JP) 2001-092692
Mar. 28, 2001 (JP) 2001-092693
Mar. 28, 2001 (JP) 2001-092694

(51) Int. Cl. C08K 3/00

(52) U.S. Cl. 523/400

(57) ABSTRACT

The present invention provides a lead-free cationic electrodeposition coating composition which contains an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst, wherein the electrodeposition coating composition has a volatile organic content of 1% by weight or less, a metal ion content of 500 ppm or less, a neutralizing acid amount of 10 to 30 mg equivalent based on 100 g of binder resin solid content. The lead-free cationic electrodeposition coating composition has high throwing power, and exert a little influence on the environment due to its low VOC, low metal ion content, and reduced consumption of a coating composition itself.

### FIELD OF THE INVENTION

The present invention relates to a lead-free cationic electrodeposition coating composition, more specifically, a lead-free cationic electrodeposition coating composition having low volatile organic content, low metal ion content and high throwing power. Further the present invention relates to an electrodeposition coating process, and a process for forming a double layered coated film which are conducted with using the lead-free cationic electrodeposition coating composition.

### BACKGROUND OF THE INVENTION

According to an electrodeposition coating method, a coated film can be formed even on narrow portions of a substrate to be coated having intricate shape, automatically and continuously. Therefore, the electrodeposition coating method is widely used for primer-coating a substrate having intricate shape and being required to have high rust resistance, such as an automobile body.

Further, an electrodeposition coating method is superior in utilization efficiency of a coating composition to the other coating method, and it has conventionally been conducted as an industrial coating method due to its economical advantage. The cationic electrodeposition coating method is conducted by dipping a substrate to be coated in an cationic electrodeposition coating composition, in which a voltage is applied with using the substrate as a cathode.

In order to improve corrosion resistance of an electrodeposition coated film, various metal catalysts including lead which act as an anti-corrosion agent have been added to the electrodeposition coating composition. However, it has been required in these days to cut down content of the metal catalyst employed in an electrodeposition coating composition because metal ion, specifically lead ion exerts a harmful effect on the environment.

On the other hand, in proportion as a concern for environmental problems has been grown, harmful air pollutants (HAPs) has been regulated in quantity more tightly over developed countries. An electrodeposition coating composition contains a volatile organic solvent to some extent as a solvent for synthesizing a resin, a flow aid for an electrodeposition coated film, a conditioning agent for coating operation, and the like. Therefore, an electrodeposition coating composition which contains HAPs in a substantial amount, may hardly be used if the environmental regulation is intensified.

It is also desired that consumption of a coating composition itself is reduced, in order to save cost for conducting an electrodeposition coating method.

Deposition of a coated film which occurs in the course of electrodeposition coating is due to an electrochemical reaction. A coated film is deposited on a surface of a substrate to be coated by a voltage being applied to an electrodeposition coating composition. The substrate is electrically insulated when a coated film is deposited thereon, and electric resistance becomes large as the deposited film becomes thick.

As a result, deposition decreases at the portion on which a coated film has been formed. Alternatively deposition increases at the portion on which no coated film has been formed. Thus, a coated film sticks to an uncoated portion of the substrate, thereby coating process is completed. As described above, a coated film is sequentially formed on the uncoated portion of the substrate during the electrodeposition coating process. Such deposition property of the electrodeposition coating composition is referred to as “throwing power” throughout the specification. An electrodeposition coating composition having good throwing power can form a coated film which has even thickness over a coated surface.

Theoretically speaking, an insulative coated film is formed on a coated surface of the substrate sequentially on the electrodeposition coating process. Therefore, throwing power must be infinity and a coated film be made uniformly over the coated surface. However in fact, since an uncoated portion of the substrate is weak in voltage to be applied, the coating solid hardly sticks to that portion. Therefore, throwing power of an electrodeposition coating composition has not been sufficient, and unevenness of film thickness may have been occurred.

An electrodeposition coated film is usually employed as a primer coating which aims at preventing corrosion or rust from generating on a substrate to be coated. Therefore, even if film thickness is uneven at portion to portion because, for example the substrate is complex in structure, the electrodeposition coating procedure have to be continued until the most thin coated part is deposited sufficiently to have a certain film thickness.

In that case, the thicker coated part is consuming excessive amount of the coating composition, and it results in wasteful consumption. Therefore, in order to increase utilization efficiency of a coating composition, throwing power have to be improved.

Various factors may be considered as to the reason of falling down the throwing power, but one of them seems to be low deposition property of a binder resin. Because a voltage applied to an uncoated portion of the substrate is weak, a coating solid is difficult to deposit on the substrate. In this situation, if the binder resin is improved in deposition property, the coating solid will deposit by the weak voltage, and a coated film will be formed uniformly on the whole coated surface of the substrate.

For example, a conventional electrodeposition coating composition has relatively low nonvolatile content, for example 20% by weight, and it has been difficult to sufficiently increase deposition property of a binder resin.

Another factor seems to be that a binder resin deposited on a surface of the substrate incompletely forms film so that the substrate is not completely insulated from a coating liquid (composition), that is the coated film is poor in electric resistance. Thus, in order to achieve high throwing power in an electrodeposition coating, a film have to be formed completely by a binder resin deposited on a surface of the substrate to raise the film resistance.

Meanwhile, a two coat one bake coating system has recently been conducted for forming a double layered coated film in order to achieve short-time coating step, energy saving, resource saving, and prevention of pollution. The two coat one bake coating system in this context means the process in which a substrate is electrodeposition coated to form an uncured coated film, a intermediate coating composition is applied thereon, in the manner of so to speak wet on wet, and the uncured double layered coated film is heated together to obtain a cured double layered coated film.

However the two coat one bake coating system involves a problem of that if thickness of the electrodeposition coated film is uneven, the intermediate coated film formed on the electrodeposition coated film also becomes poor in surface smoothness.

If the intermediate coated film is poor in surface smoothness, a top coated film formed thereon also becomes poor in surface smoothness, and surface appearance of the top coated film falls down. Therefore, the two coat one bake coating system has often caused lowering in appearance of the top coated film and served poor practical use.

### SUMMARY OF THE INVENTION

The present invention solves the above-mentioned problems of the background art, and it is an object of the present invention to provide a lead-free cationic electrodeposition coating composition which has high throwing power, and exert a little influence on the environment due to its low VOC, low metal ion content, and reduced consumption of a coating composition itself.

It is another object to provide a electrodeposition coating process which can form an electrodeposition coated film having even thickness over the whole portions of a substrate to be coated with using the lead-free cationic electrodeposition coating composition.

It is another object to provide a process for forming a double layered coated film according to the two coat one bake coating system, the intermediate coated film formed thereby is excellent in surface smoothness. As a result, a top coated film formed thereon will show excellent surface appearance.

The present invention provides a lead-free cationic electrodeposition coating composition which comprises an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst,

wherein the electrodeposition coating composition has a volatile organic content of 1% by weight or less, a metal ion content of 500 ppm or less, a neutralizing acid amount of 10 to 30 mg equivalent based on 100 g of binder resin solid content.

The lead-free cationic electrodeposition coating composition preferably has a nonvolatile content of 22 to 35% by weight.

The lead-free cationic electrodeposition coating composition preferably provides an electrodeposition coated film having a glass transition temperature of 5 to 20° C.

The lead-free cationic electrodeposition coating composition preferably provides an electrodeposition coated film having a minimum film-forming temperature of 20 to 35° C.

The present invention further provides an electrodeposition coating process comprising the steps of:

filling an electrodeposition bath with a lead-free cationic electrodeposition coating composition which comprises an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst, and which has a volatile organic content of 1% by weight or less, a metal ion content of 500 ppm or less, a neutralizing acid amount of 10 to 30 mg equivalent based on 100 g of binder resin solid content;

regulating temperature of the electrodeposition bath between the range of from the glass transition temperature of an electrodeposition coated film up to 30° C. above the glass transition temperature with the proviso that the lowest temperature is 10° C., and the highest temperature is 60° C.;

dipping a substrate to be coated in the electrodeposition coating composition; and

conducting electrodeposition coating with using the substrate as a cathode at the regulated temperature condition of electrodeposition bath to form a coated film on a surface of the substrate.

The present invention further provides a process for forming a double layered coated film comprising the steps of: conducting an electrodeposition coating method with using an electrodeposition coating composition to form an uncured electrodeposition coated film on a surface of a substrate to be coated; coating a intermediate coating composition on the electrodeposition coated film to form an uncured intermediate coated film; and baking the electrodeposition coated film and the intermediate coated film to cure simultaneously,

wherein the electrodeposition coating composition is a lead-free cationic electrodeposition coating composition which comprises an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst, and which has a volatile organic content of 1% by weight or less, a metal ion content of 500 ppm or less, a neutralizing acid amount of 10 to 30 mg equivalent based on 100 g of binder resin solid content.

### DETAILED DESCRIPTION OF THE INVENTION

An electrodeposition coating composition contains binder, pigment, solvent and various kinds of additives such as anticorrosion agent in an aqueous medium. The binder includes a cationic resin having a functional group and a curing agent for curing the cationic resin. As the aqueous medium, ion-exchanged water, deionized water, and the like are employed.

The wording “lead-free” means that lead is not substantially contained, i.e., lead is not present in an amount so as to exert an influence on the environment. Specifically it means that lead is not present in an electrodeposition bath beyond 50 ppm, preferably beyond 20 ppm.

In the present invention, the cationic epoxy resin which is obtainable by allowing an active hydrogen compound such as amine to react with an epoxy ring of an epoxy resin to introduce a cationic group by opening the epoxy group, is used as a cationic resin, and the block polyisocyanate in which an isocyanate group of polyisocyanate is blocked is used as a curing agent.

### Cationic Epoxy Resin

The cationic epoxy resin used in the present invention includes an amine-modified epoxy resin. The cationic epoxy resin may be those disclosed in Japanese Patent Kokai Publications No. Sho 54-4978 and Sho 56-34186.

The cationic epoxy resin is typically prepared by opening all epoxy rings in a bisphenol type epoxy resin by an active hydrogen compound which can introduce a cationic group, or by opening a part of epoxy rings by the other active hydrogen compound, while opening the remaining epoxy rings by an active hydrogen compound which can introduce a cationic group.

A typical example of the bisphenol type epoxy resin is the bisphenol A type or the bisphenol F type epoxy resin. The former is commercially available in the names of EPICOAT™ 828 (Yuka-Shell Epoxy Co. Ltd., epoxy equivalent 180 to 190), EPICOAT™ 1001 (epoxy equivalent 450 to 500), EPICOAT™ 1010 (epoxy equivalent 3000 to 4000) and the like, and the latter is commercially available in the name of EPICOAT™ 807 (epoxy equivalent 170) and the like.

An oxazolidone ring containing epoxy resin as described by chemical formula 3 of paragraph [0004] in Japanese Patent Kokai Publication No. Hei 5-306327 may be used as the cationic epoxy resin. This is because a coated film which is superior in throwing power, heat resistance and corrosion resistance can be obtained.

An oxazolidone ring is introduced into an epoxy resin, for example, by the step of heating a block polyisocyanate which is blocked by lower alcohol such as methanol and a polyepoxide in the presence of basic catalyst with removing lower alcohol generated as byproduct by distillation.

Especially preferred epoxy resin is an oxazolidone ring containing epoxy resin. This is because a coated film which is superior in heat resistance and corrosion resistance, as well as superior in shock resistance can be obtained.

It is known that an oxazolidone ring containing epoxy resin can be obtained by allowing a bi-functional epoxy resin to react with a diisocyanate that is blocked by monoalcohol (i.e., bisurethane). Specific examples and preparation methods of the oxazolidone ring containing epoxy resin are disclosed, for example, in paragraphs [0012] to [0047] of Japanese Patent Kokai Publication No. 2000-128959.

These epoxy resins may be modified with an appropriate resin such as polyester polyol, polyether polyol and monofunctional alkyl phenol. Furthermore, a chain of the epoxy resin may be elongated by utilizing reaction between an epoxy group and a diol or dicarboxylic acid.

These epoxy resins are favorably ring-opened by an active hydrogen compound so that amine equivalent after ring opening is 0.3 to 4.0 meq/g, and more preferably primary amino groups make up 5 to 50% of the amino groups.

An active hydrogen compound that can introduce a cationic group includes primary amine, secondary amine and acid salt of tertiary amine, sulfide and acid mixture. Preferably, primary amine, secondary amine, and/or acid salt of tertiary amine are employed as the active hydrogen compound to prepare the primary, secondary, and/or tertiary amino group containing epoxy resin of the present invention.

Specific examples of the active hydrogen compound include butylamine, octylamine, diethylamine, dibutylamine, methylbutylamine, monoethanolamine, diethanolamine, N-methylethanolamine, triethylamine hydrochloride, N, N-dimethylethanolamine acetate, diethyl disulfide/acetic acid mixture and the like, in addition to these, secondary amines obtainable by blocking primary amines such as ketimine of aminoethylethanolamine, diketimine of diethylenetriamine. A plural kinds of amines may be used.

### Block Polyisocyanate Curing Agent

Polyisocyanate used for the curing agent of the present invention refers to a compound having two or more isocyanate groups in one molecule. For example, as the polyisocyanate, it may be any of aliphatic, alicyclic, aromatic and aromatic-aliphatic.

Specific examples of the polyisocyanate include aromatic diisocyanates such as tolylenediisocyanate (TDI), diphenylmethanediisocyanate (MDI), p-phenylenediisocyanate and naphthalenediisocyanate; aliphatic diisocyanates having 3 to 12 carbon atoms such as hexamethylenediisocyanate (HDI), 2,2,4-trimethylhexanediisocyanate and lysinediisocyanate; alicyclic diisocyanates having 5 to 18 carbon atoms such as 1,4-cyclohexanediisocyanate (CDI), isophoronediisocyanate (IPDI), 4,4′-dicyclohexylmethanediisocyanate (hydrogenated MDI), methylcyclohexanediisocyanate, isopropylidene dicyclohexyl-4,4′-diisocyanate and 1,3-isocyanatomethyl cyclohexane (hydrogenated XDI), hydrogenated TDI, 2,5- or 2,6- bis (isocyanatometyl) bicyclo [2.2.1] heptane (also referred to as norbornanediisocyanate); aliphatic diisocyanates having an aromatic ring such as xylylenediisocyanate (XDI) and tetramethylxylylenediisocyanate (TMXDI); and modified diisocyanates (urethanation compounds, carbodiimide, urethodione, urethoimine, biuret and/or isocyanurate modified compounds). These may be used alone or in combination of two or more.

An adduct or a prepolymer that can be obtained by reacting polyisocyanate with polyalcohol such as ethylene glycol, propylene glycol, trimethylolpropane or hexatriol at a NCO/OH ratio of not less than 2 can also be used as a curing agent.

A block agent is those capable of adding to a polyisocyanate group, and reproducing a free isocyanate when heated to dissociation temperature though it is stable at ambient temperature.

As a block agent, those conventionally employed such as ε-caprolactam and ethylene glycol monobutyl ether may be employed. However, many of the volatile block agents among these are regulated as being HAPs, and preferably be used in minimum amount.

### Pigment

An electrodeposition coating composition generally contains pigment as a colorant. Examples of such pigment include titanium white, carbon black and colcothar. However, it is preferred that an electrodeposition coating composition of the present invention does not contain pigment. This is because throwing power of the coating composition is improved.

As to an extender pigment, or a rust preventive pigment, they may be included in order to provide corrosion resistance to a coated film. The amount however is preferably a ratio of 1/9 or less by weight based on a resin solid contained in the coating composition (PV). If the ratio of the pigment is more than 1/9 by weight, throwing power of the coating composition becomes poor, and it results in wasteful consumption of the coating composition.

Examples of such pigment may be employed in the lead-free cationic electrodeposition coating composition of the present invention include extender pigments such as kaolin, talc, aluminum silicate, calcium carbonate, mica, clay and silica, rust preventive pigments such as zinc phosphate, iron phosphate, aluminum phosphate, calcium phosphate, zinc phosphite, zinc cyanide, zinc oxide, aluminum tripoliphosphate, zinc molybdate, aluminum molybdate, calcium molybdate, aluminum phosphomolybdate, and aluminum zinc phosphomolybdate.

### Pigment Dispersion Paste

When pigment is used as a component of an electrodeposition coating composition, generally, the pigment is dispersed in an aqueous medium at high concentration in advance and made into a paste form. This is because pigment is of the powder form, and it is difficult to be dispersed uniformly into low concentration which is used in the electrodeposition coating composition, by one step process. Such a paste is generally referred to as a pigment dispersion paste.

A pigment dispersion paste is prepared by allowing pigment to disperse in an aqueous medium together with a pigment dispersing resin. Generally, as the pigment dispersing resin, cationic or nonionic low molecular weight surface active agents or cationic polymers such as modified epoxy resins having a quaternary ammonium group and/or a tertiary sulfonium group are used. As the aqueous medium, ion-exchange water or water containing a small amount of alcohol is used. Generally, the pigment dispersing resin and the pigment are used in a solid content ratio of 5 to 40 parts by weight to 20 to 50 parts by weight.

### Metal Catalyst

A metal catalyst may be included in the lead-free cationic electrodeposition coating composition of the present invention in the form of metal ion as a catalyst for improving corrosion resistance of a coated film. The metal ion includes preferably cerium ion, bithmuth ion, copper ion, and zinc ion. These are incorporated in the electrodeposition coating composition in the form of an elute derived from salts combined with suitable acids, or pigments composed of the corresponding metal. The acids may be any of inorganic or organic acids described later as a neutralizing acid such as hydrochloric acid, nitric acid, phosphoric acid, formic acid, acetic acid, and lactic acid. Preferred acid is the acetic acid.

The lead-free cationic electrodeposition coating composition of the present invention contains the metal catalyst in an amount so that metal ion concentration in the coating composition is 500 ppm or less. This is because an influence exerted on the environment is minimized. Preferably, the metal ion concentration in the coating composition is 200 to 400 ppm.

As to an amount of the metal ion, when the pigment is employed in the coating composition, it must be noticed that the metal ion may also be eluted from the pigment. Thus, the combination amount of the metal catalyst should be controlled with considering an amount of the metal ion eluted from the pigment. Examples of the metal ion eluted from the pigment include zinc ion, molybdenum ion, aluminium ion and the like.

If the metal ion is included in the electrodeposition coating composition in an amount of more than 500 ppm, an influence exerted on the environment becomes too large, deposition property of a binder resin becomes poor, and throwing power of the coating composition becomes poor. The metal ion concentration of the electrodeposition coating composition is measured by conducting atomic absorption analysis on a supernatant liquid obtained by centrifugal separation of the coating composition.

### Lead-free Electrodeposition Coating Composition

A cationic electrodeposition coating composition of the present invention is prepared by dispersing the metal catalyst, the cationic epoxy resin, the block polyisocyanate curing agent, and the pigment dispersion paste in an aqueous medium. In addition to these, the aqueous medium usually includes a neutralizing acid so that the cationic epoxy resin is neutralized to improve dispersibility of a binder resin emulsion. The neutralizing acid includes inorganic and organic acids such as hydrochloric acid, nitric acid, phosphoric acid, formic acid, acetic acid, and lactic acid.

When the coating composition includes a large amount of neutralizing acid, hydrophilicity of the cationic epoxy resin becomes high, the binder resin particles have high affinity with the aqueous medium, and dispersion stability thereof increases. This means that the binder resin particles hardly deposit on the substrate when electrodeposition coating is conducted, and means poor deposition property.

On the other hand, when the coating composition includes a small amount of neutralizing agent, hydrophilicity of the cationic epoxy resin becomes low, the binder resin particles have low affinity with the aqueous medium, and dispersion stability thereof decreases. This means that the binder resin particles easily deposit on the substrate when electrodeposition coating is conducted, and means good deposition property.

Thus, in order to improve throwing power of the electrodeposition coating composition, it is preferred that an amount of the neutralizing acid included in the coating composition is reduced to control neutralize ratio of the cationic epoxy resin to low level.

The neutralizing acid is specifically contained in an amount so as to be 10 to 30 mg eq., preferably 15 to 25 mg eq. based on 100 g of a resin solid of the binder which includes the cationic epoxy resin and the block isocyanate curing agent. If the amount of the neutralizing agent is less than 10 mg eq., the binder resin particles are insufficient or lack in affinity with water, and poor in dispersion stability. If the amount is more than 30 mg eq., the coating solid decreases in deposition property, a large quantity of electricity is required for conducting deposition, and throwing power also becomes poor.

In the present specification, the amount of the neutralizing acid is represented by milligram equivalent value based on 100 g of the binder resin solid which is contained in the coating composition, and is referred to as MEQ(A).

The amount of the block polyisocyanate curing agent is such that it is satisfactory to react with an active hydrogen containing functional group such as a primary, secondary and/or tertiary amino group or a hydroxyl group in the cationic epoxy resin at the time of heat curing and to give a preferable cured coated film. It is generally 50/50 to 90/10, preferably 65/35 to 80/20 when represented by solid content ratio by weight o fteh cationic epoxy resin based on the block polyisocyanate curing agent.

The cationic electrodeposition coating composition of the present invention may contain a tin compound such as dibutyltin dilaurate or dibutyltin oxide, or a usual urethane cleavage catalyst. The addition amount thereof is preferably 0.1 to 5.0% by weight of a resin solid.

An organic solvent is essentially required as a solvent when resin components such as a cationic epoxy resin, a block polyisocyanate curing agent, and a pigment dispersing resin and the like are prepared, and complicated procedure is required for removing the organic solvent completely. Further, when an organic solvent is contained in a binder resin, fluidity of coated film at the time of film forming is improved, and smoothness of the coated film is improved.

Examples of the organic solvent usually contained in the coating composition include ethylene glycol monobutyl ether, ethylene glycol monohexyl ether, ethylene glycol mono-2-ethylhexyl ether, propylene glycol monobutyl ether, dipropylene glycol monobutyl ether, propylene glycol monophenyl ether, and the like.

Therefore, an organic solvent have not been completely removed from a resin component conventionally, on the contrary an organic solvent is further added to the electrodeposition coating composition, thereby VOC (volatile organic content) of the coating composition is adjusted about from 1 to 5% by weight. In this context, the “volatile organic” means the organic solvent having a boiling point of 250° C. or less, the examples include the above described organic solvents.

On the other hand, the lead-free cationic electrodeposition coating composition of the present invention has the organic solvent content lower than that used to be. This is because a bad influence on the environment is prevented. Specifically, the coating composition is controlled to have a VOC of not more than 1% by weight, preferably 0.5 to 0.8% by weight, more preferably 0.2 to 0.5% by weight. If VOC of the coating composition is more than 1% by weight, an influence exerted on the environment becomes large, electric resistance of the coated film decreases due to flowability improvement of the coated film, and throwing power becomes poor.

As to the method for controlling VOC not more than 1% by weight, for example, an organic solvent employed for viscosity control at the time of conducting reaction may be reduced in its content by the reaction being conducted at higher temperature in lower solvent. An organic solvent inevitably employed at the time of conducting reaction, may be recovered by a desolvation process by such a means of employing a low boiling-point solvent, thereby VOC of the end product may be reduced. An organic solvent employed for viscosity control at the time of coating may be reduced in its content by modifying the resin with soft segment so as to have lower viscosity.

VOC may be determined by measuring amount of an organic solvent contained in the electrodeposition coating composition according to the gas liquid chromatography method by using internal standard.

In addition, the lead-free cationic electrodeposition coating composition of the present invention may contain commonly used additives for coating composition such as water miscible organic solvent, surface active agent, oxidation inhibiting agent and ultraviolet absorbing agent.

The lead-free cationic electrodeposition coating composition of the present invention preferably has a nonvolatile solid content (hereinafter may referred to as “NV solid”) of 22 to 35% by weight, more preferably 24 to 27% by weight. This is because a coating solid is sufficiently improved in deposition property. If the NV solid is less than 22% by weight, the improvement level by comparison with the conventional coating composition becomes poor. If the NV solid is more than 35% by weight, unevenness accompanied with drying, secondary sugging, or craters may be formed on the coated film, results in formation of surface discontinuity or poor working ability.

The NV solid in the coating composition may be adjusted by increasing or decreasing an amount of solid components with which the aqueous medium is combined. The NV solid may be determined by measuring weight of a certain amount sample of the coating composition before and after the sample is dried, for example at 105° C. for 3 hours.

### Electrodeposition Coating Process

The lead-free cationic electrodeposition coating composition of the present invention is coated by electrodeposition coating process on a substrate to be coated to form electrodeposition coated film (uncured). the substrate is not limited to but those having conductivity, and iron plate, steel plate, aluminum plate, and surface-treated objects thereof, and molded objects thereof can be exemplified.

Electrodeposition coating is carried out, in general, by filling an electrodeposition bath with the electrodeposition coating composition, and applying a voltage of usually 50 to 450 V between the substrate serving as cathode and anode. If the applied voltage is less than 50 V, the electrodeposition becomes insufficient, and if the applied voltage exceeds 450 V, power consumption increases, which leads lack of economy. Temperature of the electrodeposition bath in the case of applying the voltage is, generally 10 to 45° C.

The electrodeposition process preferably comprises the steps of (i) immersing a substrate to be coated in an electrodeposition coating composition, and (ii) applying a voltage between the substrate as cathode and anode to cause deposition of coated film. Also, the period of time for applying the voltage can be generally 2 to 4 minutes, though it varies with the electrodeposition condition.

The electrodeposition bath temperature is usually controlled at 10 to 45° C., however in the present invention, the temperature of the electrodeposition bath is determined based on the glass transition temperature of the electrodeposition coated film. This is for making a film to be formed completely on the substrate even when the binder resin is changed to another kind. If the electrodeposition bath temperature is more than 60° C., the coating composition is easily degraded as time elapses, and appearance failure such as unevenness accompanied with drying may also occur. If the temperature is less than 10° C., satisfactory electrodeposition coated film may not be formed.

Specifically, the temperature of the electrodeposition bath is regulated between the range of from the glass transition temperature of the electrodeposition coated film up to 30° C. above the glass transition temperature (Tg). If the temperature is less than the Tg, thermoflow of the deposited coated film is insufficient, coated film thickness becomes uneven, and the coated film resistance is prevented from rising. If the temperature is more than 30° C. above Tg, the coated film becomes too low in viscosity, also the coated film resistance is prevented from rising. The electrodeposition bath is preferably regulated from 5 to 25° C., more preferably 10 to 20° C. above the Tg.

The Tg of the binder resin described herein means the theoretical Tg value which may be work out from Tg values of the respective component resins. The Tg value may be calculated according to the Fox equation as shown below:

1/Tg=w₁/Tg₁+w₂/Tg₂+. . . +wₙ/Tgₙ

wherein wₙ represents percent by weight of the n-th resin component, and Tgₙ represents glass transition temperature of the n-th resin component (provided temperature unit is Kelvin). Tg value of one component resin may be determined by that the resin is measured in alternation of thermoabsorption rate with using a differential scanning calorimeter.

The electrodeposition coated film preferably has Tg higher than that of the electrodeposition coated film formed by the conventional electrodeposition coating composition. This is because throwing power of the electrodeposition coating composition is improved.

Specifically, the electrodeposition coated film has a Tg of 5 to 20° C. If the Tg is less than 5° C., the coated film becomes low in viscosity, the coated film resistance becomes insufficient, and throwing power becomes poor. If the Tg is more than 20° C., the coated film does not sufficiently flow by heat, and appearance becomes poor. Preferably, the electrodeposition coated film has a Tg of 5 to 15° C.

It is not clear the reason why throwing power of the electrodeposition coating composition is improved by raising Tg higher than that used to be, but it is thought that the coated film is improved so as to have high film resistance which is required for good throwing power. Tg of the electrodeposition coated film may be controlled according to any method known to those skilled in the art. For example, modifying combination ratio of component resins each of which has different Tg. The Tg of the binder resin described herein means the theoretical Tg value.

Further, the electrodeposition coated film preferably has minimum film-forming temperature (hereinafter referred to as “MFT”) higher than that of the electrodeposition coated film formed by the conventional electrodeposition coating composition. This is because throwing power of the electrodeposition coating composition is improved.

Specifically, the electrodeposition coated film has a MFT of 20 to 35° C. If the MFT is less than 20° C., the coated film may flow by small quantity of heat, film thickness easily increases, and throwing power may be harmed. If the MFT is more than 35° C., the coated film does not sufficiently flow by heat, and appearance becomes poor. Preferably the electrodeposition coated film has a MFT of 22 to 32° C.

It is not clear the reason why throwing power of the electrodeposition coating composition is improved by raising MFT higher than that used to be, but it is thought that film thickness is prevented from unnecessary increasing because the MFT comes close to the coating bath temperature, and thereby interior-exterior deposition rate is improved. The MFT of the electrodeposition coated film may be controlled according to any method known to those skilled in the art. For example, modifying combination ratio of component resins, modifying Tg of deposited resin, and modifying amount of solvent, are exemplified.

The wording “MFT” means the minimum temperature required for binding thermoplastic resin particles of the coating composition each other to form an integral film. The MFT is determined as follows.

An electrodeposition coating composition to be tested is filled in an electrodeposition bath, and is regulated to have a temperature of 10° C. A suitable substrate is dipped and applied electric current of 200 V for 3 minutes. The coated substrate is took out from the electrodeposition bath and dried. Weight of the coated film is measured. The temperature of the electrodeposition bath is raised two degrees, and the procedure is repeated. The above procedure was conducted at every two degrees up to 40° C. The temperature at which the weight of the coated film is minimum, is determined as MFT.

The electrodeposition coated film obtained in the manner as described above is baked at a temperature of 120 to 260° C., preferably 160 to 220° C. for 10 to 30 minutes to be cured directly or after being washed with water after completion of the electrodeposition process.

Thickness of the electrodeposition coated film after being cured is preferably 10 to 25 um. If it is less than 10 um, corrosion resistance is insufficient, and if it exceeds 25 um, it leads waste of the coating composition.

The electrodeposition coated object is further subjected to intermediate coating, finish coating and/or sealer coating if necessary in accordance with its purpose.

### Intermediate Coating Composition

An intermediate coating composition employed in the present invention is not limited to, but may be those usually employed as an intermediate coating composition for an automobile. The intermediate coating composition is usually thermocurable type, containing a binder and a curing agent, and having properties sufficient for use in automotive intermediate coating such as adhesiveness, smoothness, clear looking, overbake resistance, weather resistance, and the like. The binder usually includes, for example an acryl resin, a polyester resin, an alkyd resin, and an epoxy resin.

The acryl resin includes those copolymerized from ethylenically unsaturated monomers by a conventional method. The ethylenically unsaturated monomers are not limited to, but include, for example hydroxyl group containing monomers such as 2-hydroxyethyl (meth)acrylate, 2-hydroxypropyl (meth)acrylate, 4-hydroxybutyl (meth)acrylate, PLACCEL FM™ series (adduct of 2-hydroxyethyl (meth)acrylate and polycaprolactone, available from Daicel Kagaku Kogyo K.K.), polyalkylene glycol mono(meth)acrylate; epoxy group containing monomers such as glycidyl (meth)acrylate, 2-methyl glycidyl (meth)acrylate; amino group containing monomers such as dimethyl aminoethyl (meth)acrylate, diethyl aminoethyl (meth)acrylate; acrylamide monomers such as (meth)acrylamide, N-methyl(met)acrylamide, N-butoxymethyl(meth)acrylamide, N-methylacrylamide, and the like. The other monomers such as acrylonitrile, vinyl acetate, (meth)acrylic acid, methyl (meth)acrylate, ethyl (meth)acrylate, n-butyl (meth)acrylate, isobutyl (meth)acrylate, tert-butyl (meth)acrylate, styrene, vinyl toluene, p-chlorostyrene, may be used. These may be employed alone or in combination of two or more.

The polyester resin may be prepared by condensation polymerizing an acid component mainly composed of polyfunctional carboxylic acid with an alcohol component mainly composed of polyhydric alcohol according to conventional method. The acid component is not limited to, but includes, for example aromatic dicarboxylic acids such as terephthalic acid, isophthalic acid, phthalic acid, 2,6-naphthalene dicarboxylic acid, 2,7-naphthalene dicarboxylic acid, and anhydrides thereof; aliphatic dicarboxylic acids such as succinic acid, adipic acid, azelaic acid, sebacic acid, dodecanoic dicarboxylic acid, 1,4-cyclohexane dicarboxylic acid, and anhydrides thereof; lactones such as γ-butylolactone, ε-caprolactone; aromatic oxymonocarboxylic acids such as p-oxyethoxybenzoic acid; and hydroxycarboxylic acids corresponding thereto. These may be employed alone or in combination of two or more.

The polyhydric alcohol is not limited to, but includes, for example aliphatic glycols which may have a side chain such as ethylene glycol, 1,3-propane diol, 1,4-butane diol, 1,5-pentane diol, 1,5-hexane diol, diethylene glycol, triethylene glycol, 1,4-cyclohexane diol, 1,4-cyclohexane dimethanol, bisphenol A alkylene oxide adduct, bisphenol S alkylene oxide adduct, 1,2-propane diol, neopentyl glycol, 1,2-butane diol, 1,3-butane diol, 1,2-pentane diol, 2,3-pentane diol, 1,4-pentane diol, 1,4-hexane diol, 2,5-hexane diol, 3-methyl-1,5-pentane diol, 1,2-dodecane diol, 1,2-octadecane diol; polyhydric alcohols not less than trihydric such as trimethylol propane, glycerol, pentaerythritol. These may be employed alone or in combination of two or more.

The alkyd resin may be prepared by condensation polymerizing the acid component with the alcohol component employed for preparation of the polyester resin, in addition with monohydric alcohol according to conventional method. The monohydric alcohol is not limited to, but includes, for example soybean oil, safflower oil, palm oil, castor oil, benzoic acid, and the like. As storage stability of a coating composition, and weather resistance of a coated film is concerned, the alkyd resin is preferred to be short oil or super short oil having an oil length of not more than 30% when it is employed as an intermediate coating for an automobile.

The epoxy resin includes, for example, the compound which has two or more glycidyl group (includes oxirane). Specific examples include a glycidyl ester resin; a glycidyl ether resin such as condensate of bisphenol A and epichlorohydrin, condensate of bisphenol F and epichlorohydrin; an alicyclic epoxy resin, a cotton form aliphatic epoxy resin, a bromine containing epoxy resin, a phenolic novolak epoxy resin, a cresol novolak epoxy resin, and the like.

The curing agent includes various compounds depending on a curable functional group included in the binder. For example, when the binder has a hydroxyl group as a functional group, the curing agent may be selected from an amino resin, a block polyisocyanate compound, aliphatic polycarboxylic acid and anhydride thereof, an epoxy resin. These may be employed alone or in combination of two or more unless curability is inhibited.

The amino resin includes, for example a melamine resin, a benzoguanamine resin, an urea resin, a glycol lauryl resin, and the like. The melamine resin includes an alkyl etherified melamine substituted by melamine or an alkylether group. The alkylether group includes a methoxy group or a butoxy group.

The block polyisocyanate compound means the compound obtainable by blocking a polyisocyanate compound with a block agent. The polyisocyanate compound is not limited to, providing at least two isocyanate groups are present in a molecule, but includes, for example aliphatic diisocyanates such as hexamethylenediisocyanate, trimethylhexamethylenediisocyanate; alicyclic diisocyanates such as isophoronediisocyanate, aromatic diisocyanates such as tolylenediisocyanate, 4,4′-diphenylmethanediisocyanate; dimer acid diisocyanates; hydrogenated diisocyanates; dimers, trimers of the polyisocyanate, or higher molecular weight polyisocyanates; adducts of the polyisocyanate with polyhydric alcohols such as trimethylol propane, water, or low molecular weight polyester resin. These may be employed alone or in combination of two or more.

The block agent is not limited to, but includes, for example oximes such as methyl ethyl ketoxime, acetoxime, cyclohexanone oxime, acetophenone oxime, benzophenone oxime; phenols such as m-cresol, xylenol; alcohols such as methanol, butanol, 2-ethyl hexanol, cyclohexanol, ethylene glycol monomethyl ether; lactams such as ε-caprolactam; diketones such as diethyl malonate and acetoacetate; mercaptanes such as thiophenol; ureas such as thiourea; imidazoles; carbamic acids, and the like.

The aliphatic polycarboxylic acid includes aliphatic dicarboxylic acids described as to the polyester resin. The epoxy resin include polyepoxydes such as the epoxy resins described as to the curing agent, and triglycidyl isocyanurate.

When the binder has an acidic group as the curable functional group, the above described epoxy resin is usually employed as a curing agent, in addition, a polyhydroxy compound and hydroxyalkylamide may be employed.

The intermediate coating composition employed in the present invention may have various forms of a solvent based form, an aqueous based form, a water dispersion form, or a powder form. The form may be varied by the method well known to those skilled in the art. For example, the aqueous or the water dispersion form is prepared by introducing a hydrophilic group such as an acidic group into the binder resin, and neutralizing with basic compounds such as amine. The powder form may be prepared by adjusting the glass transition temperature of the binder and the curing agent beyond room temperature.

In addition, the intermediate coating composition to be used in the present invention may optionally contain coloration pigment, extender pigment, surface controlling agent, leveling agent, UV absorbing agent, photostabilizing agent, charge preventing agent, thixotropy providing agent, and the like.

The intermediate coating composition is preferably prepared to have a curing temperature of from 110 to 200° C. If the curing temperature is less than 110° C., the resulting double layered coated film may become poor in surface smoothness, or the multilayered coated film obtainable by coating a top coating composition thereon may become poor in appearance. If the curing temperature is more than 200° C., the resulting double layered coated film may become poor in physical properties, or the multilayered coated film obtainable by coating a top coating composition thereon may become poor in appearance. The curing temperature may be controlled by the manner well known to those skilled in the art such as altering the curing functional groups, or the curing agents in amount or kind thereof.

The curing temperature of the intermediate coating composition preferably satisfy the equation of that:

Tᵢₙₜ−T_{cat}=−35 to 15° C. I

wherein Tᵢₙₜ represents curing temperature of the intermediate coating composition, and T_{cat} represents curing temperature of the cationic electrodeposition coating composition. If the value I is more than 15° C., the resulting double layered coated film may become poor in physical properties. If the value I is less than −35° C., the resulting double layered coated film may become poor in surface smoothness, or may have color difference.

### Process for Forming Double Layered Coated Film

In the process for forming double layered coated film of the present invention, the intermediate coating composition prepared as described above is applied on an uncured electrodeposition coated film. The uncured electrodeposition coated film may be prepared according to the electrodeposition coating process of the present invention.

The process for applying the intermediate coating composition is not limited to, but any process known to those skilled in the art may be used dependent on the form of the intermediate coating composition. For example, spray coating method, brush coating method, dip coating method, and electrostatic coating method may be employed. Among these, the electrostatic coating method is preferably employed for the coating step of an automobile body manufacturing line. The intermediate coating composition is applied so as to have a thickness in dry state of 10 to 50 um, preferably 20 to 30 um. Then, the substrate which has an uncured electrodeposition coated film and an uncured intermediate coated film thereon, is subject to setting for predetermined period of time.

The electrodeposition coated film and the intermediate coated film are then baked to cure. The method for baking the coated films is that the coated substrate is placed in a drying oven heated to the temperature 0 to 15° C. beyond the curing temperature of the electrodeposition coated film, and heated for 10 to 60 minutes. Thereby, a double layered coated film which is cured, is obtained.

The present invention will be further explained in detail in accordance with the following examples, however, the present invention is not limited to these examples. In the examples, “part” and “%” are based on weight unless otherwise specified. “Epoxy equivalent” and “amine equivalent” are values per solid content.

### EXAMPLE A

### Preparation Example A1

### Preparation of Amine-modified Epoxy Resin

92 parts of 2,4-/2,6-tolylenediisocyanate (weight ratio=8/2), 95 parts of methyl isobutyl ketone (hereinafter, referred to as MIBK) and 0.5 part of dibutyltin dilaurate were loaded to a flask equipped with a stirrer, a cooling tube, a nitrogen introducing tube, a thermometer and a dropping funnel. 21 parts of methanol was added while stirring the mixture.

Starting at room temperature, the reaction mixture was allowed to rise to 60° C. by exothermic, the reaction was retained for 30 minutes, and 57 parts of ethylene glycol mono-2-ethylhexyl ether was dropped from the dropping funnel. Furthermore, 42 parts of bisphenol A-propylene oxide 5 mol adduct was added. The reaction was carried out mainly in the temperature range of 60 to 65° C., and continued until absorption based on an isocyanate group disappeared in IR spectrum measurement.

Next, 365 parts of bisphenol A type epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 410.

Subsequently, 87 parts of bisphenol A was added and allowed to react at 120° C. to achieve epoxy equivalent of 1190. Thereafter, the reaction mixture was cooled, and 11 parts of diethanolamine, 24 parts of N-ethylethanolamine and 25 parts of 79% solution in MIBK of ketimined aminoethyl ethanolamine were added, and was allowed to react for 2 hours at 110° C. Then, the reaction mixture was diluted with MIBK until NV solid became 80%, and an amino-modified epoxy resin (solid content: 80%) was obtained.

### Preparation Example A2

### Preparation of Block Polyisocyanate Curing Agent

1250 parts of diphenylmethanediisocyanate, 266.4 parts of MIBK were loaded to a flask, this was heated to 80° C., and 2.5 parts of dibutyltin dilaurate were added to this. A solution of 226 parts of ε-caprolactam dissolved in 944 parts of ethylene glycol monobutyl ether was dropped thereto at 80° C. over 2 hours. The reaction was retained at 100° C. for 4 hours, it was confirmed that absorption based on an isocyanate group disappeared in IR spectrum measurement, and left to be cooled. 336.1 parts of MIBK were added and thereby, a block polyisocyanate curing agent was obtained.

### Preparation Example A3

### Preparation of Pigment Dispersing Resin

222.0 parts of isophoronediisocyanate (hereinafter, referred to as IPDI) was loaded in a reaction vessel equipped with a stirrer, a cooling tube, a nitrogen introducing tube and a thermometer, and after diluted with 39.1 parts of MIBK, 0.2 part of dibutyltin laurate was added. Then, the reaction mixture was heated to 50° C., and 131.5 parts of 2-ethyl hexanol was dropped under dry nitrogen atmosphere over 2 hours with stirring. Reaction temperature was kept at 50° C. by cooling as necessary. As a result of this, 2-ethyl hexanol half blocked IPDI (solid content: 90%) was obtained.

87.2 parts of dimethylethanolamine, 117.6 parts of 75% aqueous solution of lactic acid, and 39.2 parts of ethylene glycol monobutyl ether were added to a suitable reaction vessel, the reaction mixture was stirred at 65° C. for half an hour to prepare a quaternarizing agent.

Subsequently 710.0 parts of EPON 829 (bisphenol A type epoxy resin manufactured by Shell Chemical Company, epoxy equivalents 193 to 203), and 289.6 parts of bisphenol A were loaded to a reaction vessel. The reaction mixture was heated to 150 to 160° C. under nitrogen atmosphere, exothermic reaction was initially occurred. Heating was continued at 150 to 160° C. for about 1 hour, the reaction mixture was then cooled to 120° C., 498.8 parts of the prepared 2-ethyl hexanol half-blocked IPDI (MIBK solution) was added.

The reaction mixture was held at 110 to 120° C. for 1 hour, 1390.2 parts of ethylene glycol monobutyl ether were added, the mixture was cooled to 85 to 90° C., homogenized, and 196.7 parts of the prepared quaternarizing agent was added thereto. The reaction mixture was held at 85 to 90° C. until the acid value became 1, 37.0 parts of deionized water were added to finalize quaternarization of an epoxy-bisphenol A resin and to obtain a pigment dispersing resin having quaternary ammonium moiety (solid content: 50%).

### Preparation Example A4

### Preparation of Pigment Dispersion Paste

120 parts of the pigment dispersing resin obtained in Preparation example A3, 2.0 parts of carbon black, 100.0 parts of kaolin, 80.0 parts of titanium dioxide, 18.0 parts of aluminum phosphomolibudate and 221.7 parts of ion-exchange water were loaded into a sand grinding mill, and they were dispersed until grain size was not more than 10 um, to obtain a pigment dispersion paste (solid content: 48%).

### EXAMPLE A1

### Preparation of Electrodeposition Coating Composition

The amine-modified epoxy resin obtained in Preparation example A1 and the block polyisocyanate curing agent obtained in Preparation example A2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 24, and ion-exchanged water was slowly added for dilution. MIBK was removed under reduced pressure to obtain an emulsion having a solid content of 36%.

1960 parts of this emulsion, 197 parts of the pigment dispersion paste obtained in Preparation example A4, 1805 parts of ion-exchanged water, 38 parts of 10% cerium acetate aqueous solution, and 14.5 parts of dibutyltin oxide were mixed, and a cationic electrodeposition coating composition having a solid content of 20.0% was obtained. This electrodeposition coating composition had a solid content ratio by weight between the pigment and the total resin (P/V) of 1/10, a volatile organic content in the coating composition (VOC) of 0.9%, a milligram equivalent value of acid based on 100 g of the binder resin solid content (MEQ(A)) of 25.2, and a total concentration of the eluted cerium ion and zinc ion of 420 ppm.

### EXAMPLE A2

### Preparation of Electrodeposition Coating Composition

The amine-modified epoxy resin obtained in Preparation example A1 and the block polyisocyanate curing agent obtained in Preparation example A2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 21, and ion-exchanged water was slowly added for dilution. MIBK was removed under reduced pressure to obtain an emulsion having a solid content of 36%.

2222 parts of this emulsion, 1759 parts of ion-exchanged water, 38 parts of 10% cerium acetate aqueous solution, and 16 parts of dibutyltin oxide were mixed, and a cationic electrodeposition coating composition having a solid content of 20.0% was obtained. This electrodeposition coating composition had substantially no pigment, a VOC of 0.4%, a MEQ(A) of 25.6, a total concentration of the eluted cerium ion and zinc ion of 405 ppm.

### EXAMPLE A3

### Preparation of Electrodeposition Coating Composition

The amine-modified epoxy resin obtained in Preparation example A1 and the block polyisocyanate curing agent obtained in Preparation example A2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 23, and ion-exchanged water was slowly added for dilution. MIBK was removed under reduced pressure to obtain an emulsion having a solid content of 36%.

2222 parts of this emulsion, 1759 parts of ion-exchanged water, 19 parts of 10% cerium acetate aqueous solution, and 16 parts of dibutyltin oxide were mixed, and a cationic electrodeposition coating composition having a solid content of 20.0% was obtained. This electrodeposition coating composition had substantially no pigment, a VOC of 0.4%, a MEQ(A) of 25.0, a total concentration of the eluted cerium ion and zinc ion of 205 ppm.

### EXAMPLE A4

### Preparation of Electrodeposition Coating Composition

The amine-modified epoxy resin obtained in Preparation example A1 and the block polyisocyanate curing agent obtained in Preparation example A2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 18, and ion-exchanged water was slowly added for dilution. MIBK was removed under reduced pressure to obtain an emulsion having a solid content of 36%.

2222 parts of this emulsion, 1759 parts of ion-exchanged water, 19 parts of 10% cerium acetate aqueous solution, and 16 parts of dibutyltin oxide were mixed, and a cationic electrodeposition coating composition having a solid content of 20.0% was obtained. This electrodeposition coating composition had substantially no pigment, a VOC of 0.4%, a MEQ(A) of 20.4, a total concentration of the eluted cerium ion and zinc ion of 190 ppm.

### Comparative Example A

### Preparation of Electrodeposition Coating Composition

The amine-modified epoxy resin obtained in Preparation example A1 and the block polyisocyanate curing agent obtained in Preparation example A2 were uniformly mixed in solid content ratio of 70:30. Ethylene glycol 2-ethylhexyl ether was then added so that the amount based on solid content was 1%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 542 parts of pigment dispersion paste prepared in Preparation example A4, 1901 parts of ion-exchanged water, 57 parts of 10% cerium acetate aqueous solution, and 9 parts of dibutyltin oxide were mixed, and a cationic electrodeposition coating composition having a solid content of 20.0% was obtained. This electrodeposition coating composition had a PIV of 1/3, a VOC of 1.5%, a MEQ(A) of 30.3, and a total concentration of the eluted cerium ion and zinc ion of 610 ppm.

The electrodeposition coating compositions prepared in Examples and Comparative Examples were evaluated as shown in the following procedures.

(1) Throwing Power

Ford pipe method was conducted. Evaluation was made according to the following criteria.

Good: not less than 21 cm

Poor: less than 21 cm

(2) Salt Dipping Corrosion Resistance

Electrodeposition coating was conducted on a cold rolled steel plate which had been treated with phosphoric acid so that the resulting electrodeposition coated film had a thickness in dry state of 20 um. The coated film was rinsed with deionized water, and was baked at 170° C. for 25 minutes to obtain a cured coated film. A linear flaw reaches a surfaces of the steel plate having suitable length was made on the coated film with a cutter knife.

The coated steel plate was dipped into 5% brine at 55° C. for 240 hours. CELLOPHANE TAPE™ available from Nichiban K.K. was fixed on the surface of the coated film so that the flaw was covered, the tape was then rapidly peeled. The coated film was partly removed with the tape along the flaw at certain width. Evaluation was made in accordance with maximum width of the removed part with the following criteria.

Good: less than 3 mm

Middle: 3 to 6 mm

Poor: more than 6 mm

(3) Smoothness

Electrodeposition coating was conducted on an untreated zinc phosphate steel plate so that the resulting electrodeposition coated film had a thickness in dry state of 20 um. The coated film was rinsed with deionized water, and was baked at 160° C. for 10 minutes to obtain a cured coated film. Surface roughness (Ra) of the cured coated film was measured by using a surface roughness meter SURFTEST-211 (manufactured by Mitsutoyo K.K.) under a cut off of 0.8 mm, and a scan length of 4 mm. Evaluation was made according to the following criteria.

Good: less than 0.2 um of Ra

Poor: not less than 0.2 um of Ra

(4) Storage Stability

The electrodeposition coating composition was stored at 40° C. for 2 weeks. Then, it was filtrated with using a mesh of No. 380. Evaluation was made according to the following criteria.

Good: Passed through

Poor: Not passed through

TABLE A

| | Ex. A1 | Ex. A2 | Ex. A3 | Ex. A4 | CEx. A |
|---|---|---|---|---|---|
| VOC/% | 0.9 | 0.4 | 0.4 | 0.4 | 1.5 |
| MEQ(A)/ | 25.2 | 25.6 | 25.0 | 20.4 | 30.3 |
| mgeq. | | | | | |
| Metal ion | 420 | 405 | 205 | 190 | 610 |
| conc./ppm | | | | | |
| P/V | 1/10 | 0 | 0 | 0 | 1/3 |
| Throwing | G | G | G | G | P |
| power | | | | | |
| Corrosion | G | G | G | G | G |
| resist. | | | | | |
| Smooth- | G | G | G | G | P |
| ness | | | | | |
| Stability | G | G | G | G | G |

### EXAMPLE B

### Preparation Example B1

### Preparation of Amine-modified Epoxy Resin

An amine modified epoxy resin was prepared according to substantially the same manner as described in Preparation example A1.

### Preparation Example B2

### Preparation of Block Polyisocyanate Curing Agent

A block polyisocyanate curing agent was prepared according to substantially the same manner as described in Preparation example A2.

### Preparation Example B3

### Preparation of Pigment Dispersing Resin

A pigment dispersing resin was prepared according to substantially the same manner as described in Preparation example A3.

### Preparation Example B4

### Preparation of Low Solvent Pigment Dispersing Resin

A low solvent pigment dispersing resin (solid content: 50%) was prepared according to the same manner as described in Preparation example B3 except that amount of ethylene glycol monobutyl ether added just before the quaternarization step was reduced to 463.4 parts.

### Preparation Example B5

### Preparation of Pigment Dispersion Paste

120 parts of the pigment dispersing resin obtained in Preparation example B3, 2.0 parts of carbon black, 100.0 parts of kaolin, 80.0 parts of titanium dioxide, 18.0 parts of aluminum phosphomolibudate and 221.7 parts of ion-exchange water were loaded into a sand grinding mill, and they were dispersed until grain size was not more than 10 um, to obtain a pigment dispersion paste (solid content: 48%).

### Preparation Example B6

### Preparation of low Solvent Pigment Dispersion Paste

A low solvent pigment dispersion paste (solid content: 48%) was prepared according to the same manner as described in Preparation example B5 except that the low solvent pigment dispersing resin prepared in Preparation example B4 was employed instead of the pigment dispersing resin obtained in Preparation example B3.

### EXAMPLE B1

### Preparation of Electrodeposition Coating Composition

The amine-modified epoxy resin obtained in Preparation example B 1 and the block polyisocyanate curing agent obtained in Preparation example B2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1800 parts of this emulsion, 650 parts of the pigment dispersion paste obtained in Preparation example B6, 1530 parts of ion-exchanged water, 20 parts of 10% cerium acetate aqueous solution, and 10 parts of dibutyltin oxide were mixed, and a cationic electrodeposition coating composition having a solid content of 24% was obtained. This electrodeposition coating composition had a volatile organic content in the coating composition (VOC) of 0.9%, a milligram equivalent value of acid based on 100 g of the binder resin solid content (MEQ(A)) of 24.5, and a total concentration of the eluted cerium ion and zinc ion of 210 ppm.

### EXAMPLE B2

### Preparation of Electrodeposition Coating Composition

The amine-modified epoxy resin obtained in Preparation example B1 and the block polyisocyanate curing agent obtained in Preparation example B2 were uniformly mixed in solid content ratio of 70:30. Ethylene glycol 2-ethylhexyl ether was then added so that the amount based on solid content was 1%, and glacial acetic acid was added so that milligram equivalent value of acid based on 100 g of the binder resin solid content MEQ(A) was 28, and ion-exchanged water was slowly added for dilution. MIBK was removed under reduced pressure to obtain an emulsion having a solid content of 36%.

2250 parts of this emulsion, 813 parts of the pigment dispersion paste obtained in Preparation example B6, 920 parts of ion-exchanged water, 20 parts of 10% cerium acetate aqueous solution, and 14 parts of dibutyltin oxide were mixed, and a cationic electrodeposition coating composition having a solid content of 30% was obtained. This electrodeposition coating composition had a VOC of 0.9%, a MEQ(A) of 20.3, a total concentration of the eluted cerium ion and zinc ion of 190 ppm.

### EXAMPLE B3

### Preparation of Electrodeposition Coating Composition

The amine-modified epoxy resin obtained in Preparation example B 1 and the block polyisocyanate curing agent obtained in Preparation example B2 were uniformly mixed in solid content ratio of 70:30. Glacial acetic acid was added to this so that milligram equivalent value of acid based on 100 g of the binder resin solid content MEQ(A) was 28, and ion-exchanged water was slowly added for dilution. MIBK was removed under reduced pressure to obtain an emulsion having a solid content of 36%.

2550 parts of this emulsion, 920 parts of the pigment dispersion paste obtained in Preparation example B6, 510 parts of ion-exchanged water, 20 parts of 10% cerium acetate aqueous solution, and 15 parts of dibutyltin oxide were mixed, and a cationic electrodeposition coating composition having a solid content of 34% was obtained. This electrodeposition coating composition had a VOC of 0.8%, a MEQ(A) of 20.1, a total concentration of the eluted cerium ion and zinc ion of 205 ppm.

### Comparative Example B

### Preparation of Electrodeposition Coating Composition

The amine-modified epoxy resin obtained in Preparation example B1 and the block polyisocyanate curing agent obtained in Preparation example B2 were uniformly mixed in solid content ratio of 70:30. Ethylene glycol 2-ethylhexyl ether was then added so that the amount based on solid content was 1%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 542 parts of pigment dispersion paste prepared in Preparation example B5, 1901 parts of ion-exchanged water, 57 parts of 10% cerium acetate aqueous solution, and 9 parts of dibutyltin oxide were mixed, and a cationic electrodeposition coating composition having a solid content of 20.0% was obtained. This electrodeposition coating composition had a VOC of 1.5%, a MEQ(A) of 30.3, and a total concentration of the eluted cerium ion and zinc ion of 610 ppm.

The electrodeposition coating compositions prepared in Examples and Comparative Examples were evaluated according to the same manner as described in (1) to (4) of Example A.

TABLE B

| | Ex. B1 | Ex. B2 | Ex. B3 | CEx. B |
|---|---|---|---|---|
| VOC/% | 0.9 | 0.9 | 0.8 | 1.5 |
| MEQ(A)/ | 24.5 | 20.3 | 20.1 | 30.3 |
| mgeq. | | | | |
| Metal ion | 210 | 190 | 205 | 610 |
| conc./ppm | | | | |
| NV | 24 | 30 | 34 | 20 |
| solid/% | | | | |
| Throwing | G | G | G | P |
| power | | | | |
| Corrosion | G | G | G | G |
| resist. | | | | |
| Smooth- | G | G | G | P |
| ness | | | | |
| Stability | G | G | G | G |

### EXAMPLE C

### Preparation Example C1

### Preparation of Amine-modified Epoxy Resin

92 parts of 2,4-/2,6-tolylenediisocyanate (weight ratio=8/2), 95 parts of methyl isobutyl ketone (hereinafter, referred to as MIBK) and 0.5 part of dibutyltin dilaurate were loaded to a flask equipped with a stirrer, a cooling tube, a nitrogen introducing tube, a thermometer and a dropping funnel. 21 parts of methanol was added while stirring the mixture.

Starting at room temperature, the reaction mixture was allowed to rise to 60° C. by exothermic, the reaction was retained for 30 minutes, and 50 parts of ethylene glycol mono-2-ethylhexyl ether was dropped from the dropping funnel. Furthermore, 53 parts of bisphenol A-propylene oxide 5 mol adduct was added. The reaction was carried out mainly in the temperature range of 60 to 65° C., and continued until absorption based on an isocyanate group disappeared in IR spectrum measurement.

Next, 365 parts of bisphenol A type epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 410.

Subsequently, 61 parts of bisphenol A and 33 parts of octylic acid was added and allowed to react at 120° C. to achieve epoxy equivalent of 1190. Thereafter, the reaction mixture was cooled, and 11 parts of diethanolamine, 24 parts of N-ethylethanolamine and 25 parts of 79% solution in MIBK of ketimined aminoethyl ethanolamine were added, and was allowed to react for 2 hours at 110° C. Then, the reaction mixture was diluted with MIBK until NV solid became 80%, and an amino-modified epoxy resin which has a glass transition temperature (Tg) of 2° C. (solid content: 80%) was obtained.

### Preparation Example C2

### Preparation of Amine-modified Epoxy Resin

92 parts of 2,4-/2,6-tolylenediisocyanate (weight ratio=8/2), 95 parts of MIBK and 0.5 part of dibutyltin dilaurate were loaded to a flask equipped with a stirrer, a cooling tube, a nitrogen introducing tube, a thermometer and a dropping funnel. 21 parts of methanol was added while stirring the mixture.

Starting at room temperature, the reaction mixture was allowed to rise to 60° C. by exothermic, the reaction was retained for 30 minutes, and 57 parts of ethylene glycol mono-2-ethylhexyl ether was dropped from the dropping funnel. Furthermore, 42 parts of bisphenol A-propylene oxide 5 mol adduct was added. The reaction was carried out mainly in the temperature range of 60 to 65° C., and continued until absorption based on an isocyanate group disappeared in IR spectrum measurement.

Next, 365 parts of bisphenol A type epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 410.

Subsequently, 87 parts of bisphenol A was added and allowed to react at 120° C. to achieve epoxy equivalent of 1190. Thereafter, the reaction mixture was cooled, and 11 parts of diethanolamine, 24 parts of N-ethylethanolamine and 25 parts of 79% solution in MIBK of ketimined aminoethyl ethanolamine were added, and was allowed to react for 2 hours at 110° C. Then, the reaction mixture was diluted with MIBK until NV solid became 80%, and an amino-modified epoxy resin which has a Tg of 22° C. (solid content: 80%) was obtained.

### Preparation Example C3

### Preparation of Block Polyisocyanate Curing Agent

A block polyisocyanate curing agent was prepared according to substantially the same manner as described in Preparation example A2. The block polyisocyanate curing agent had a Tg of 0° C.

### Preparation Example C4

### Preparation of Pigment Dispersing Resin

222.0 parts of isophoronediisocyanate (hereinafter, referred to as IPDI) was loaded in a reaction vessel equipped with a stirrer, a cooling tube, a nitrogen introducing tube and a thermometer, and after diluted with 39.1 parts of MIBK, 0.2 part of dibutyltin laurate was added. Then, the reaction mixture was heated to 50° C., and 131.5 parts of 2-ethyl hexanol was dropped under dry nitrogen atmosphere over 2 hours with stirring. Reaction temperature was kept at 50° C. by cooling as necessary. As a result of this, 2-ethyl hexanol half blocked IPDI (solid content: 90%) was obtained.

87.2 parts of dimethylethanolamine, 117.6 parts of 75% aqueous solution of lactic acid, and 39.2 parts of ethylene glycol monobutyl ether were added to a suitable reaction vessel, the reaction mixture was stirred at 65° C. for half an hour to prepare a quaternarizing agent.

Subsequently 710.0 parts of EPON 829 (bisphenol A type epoxy resin manufactured by Shell Chemical Company, epoxy equivalents 193 to 203), and 289.6 parts of bisphenol A were loaded to a reaction vessel. The reaction mixture was heated to 150 to 160° C. under nitrogen atmosphere, exothermic reaction was initially occurred. Heating was continued at 150 to 160° C. for about 1 hour, the reaction mixture was then cooled to 120° C., 498.8 parts of the prepared 2-ethyl hexanol half-blocked IPDI (MIBK solution) was added.

The reaction mixture was held at 110 to 120° C. for 1 hour, 463.4 parts of ethylene glycol monobutyl ether were added, the mixture was cooled to 85 to 90° C., homogenized, and 196.7 parts of the prepared quaternarizing agent was added thereto. The reaction mixture was held at 85 to 90° C. until the acid value became 1, 964 parts of deionized water were added to finalize quaternarization of an epoxy-bisphenol A resin and to obtain a pigment dispersing resin having quaternary ammonium moiety (Tg: 5° C., solid content: 50%).

### Preparation Example C5

### Preparation of Pigment Dispersion Paste

120 parts of the pigment dispersing resin obtained in Preparation example C4, 2.0 parts of carbon black, 100.0 parts of kaolin, 80.0 parts of titanium dioxide, 18.0 parts of aluminum phosphomolibudate and 221.7 parts of ion-exchange water were loaded into a sand grinding mill, and they were dispersed until grain size was not more than 10 um, to obtain a pigment dispersion paste (solid content: 48%).

### EXAMPLE C1

### Preparation of Electrodeposition Coating Composition

The amine-modified epoxy resins obtained in Preparation examples C1 and C2, the block polyisocyanate curing agent obtained in Preparation example C3 were uniformly mixed in solid content ratio of 40:30:30. Glacial acetic acid was added to this so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of the pigment dispersion paste obtained in Preparation example C5, 1940 parts of ion-exchanged water, 20 parts of 10% cerium acetate aqueous solution, and 10 parts of dibutyltin oxide were mixed, and a cationic electrodeposition coating composition having a solid content of 20.0% was obtained. The electrodeposition coating composition had a volatile organic content in the coating composition (VOC) of 0.5%, a milligram equivalent value of acid based on 100 g of the binder resin solid content (MEQ(A)) of 25.7, and a total concentration of the eluted cerium ion and zinc ion of 210 ppm. Tg of the electrodeposition coated film deposited therefrom (uncured) was calculated from the Tgs of the respective component resins and found to be 7° C.

### EXAMPLE C2

### Preparation of Electrodeposition Coating Composition

The amine-modified epoxy resins obtained in Preparation examples C1 and C2, and the block polyisocyanate curing agent obtained in Preparation example C3 were uniformly mixed in solid content ratio of 20:50:30. Glacial acetic acid was added to this so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of the pigment dispersion paste obtained in Preparation example C5, 1940 parts of ion-exchanged water, 20 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.5%, a MEQ(A) of 25.2, a total concentration of the eluted cerium ion and zinc ion of 200 ppm. Tg of the electrodeposition coated film deposited therefrom (uncured) was calculated to be 10° C.

### EXAMPLE C3

### Preparation of Electrodeposition Coating Composition

The amine-modified epoxy resin obtained in Preparation example C2 and the block polyisocyanate curing agent obtained in Preparation example C3 were uniformly mixed in solid content ratio of 70:30. Glacial acetic acid was added to this so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of the pigment dispersion paste obtained in Preparation example C5, 1940 parts of ion-exchanged water, 20 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.5%, a MEQ(A) of 25.5, a total concentration of the eluted cerium ion and zinc ion of 205 ppm. Tg of the electrodeposition coated film deposited therefrom (uncured) was calculated to be 14° C.

### Comparative Example C

### Preparation of Electrodeposition Coating Composition

The amine-modified epoxy resin obtained in Preparation example C1 and the block polyisocyanate curing agent obtained in Preparation example C4 were uniformly mixed in solid content ratio of 70:30. Ethylene glycol 2-ethylhexyl ether was then added so that the amount based on solid content was 3%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of pigment dispersion paste prepared in Preparation example C6, 1900 parts of ion-exchanged water, 60 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.9%, a MEQ(A) of 29.7, and a total concentration of the eluted cerium ion and zinc ion of 580 ppm. Tg of the electrodeposition coated film deposited therefrom (uncured) was calculated to be 1.5° C.

The electrodeposition coating compositions prepared in Examples and Comparative Examples were evaluated according to the same manner as described in (1) to (4) of Example A.

TABLE C

| | Ex. C1 | Ex. C2 | Ex. C3 | CEx. C |
|---|---|---|---|---|
| Tg/° C. | 7 | 10 | 14 | 1.5 |
| VOC/% | 0.5 | 0.5 | 0.5 | 0.9 |
| MEQ(A)/ | 25.7 | 25.2 | 25.5 | 29.7 |
| mgeq. | | | | |
| Metal ion | 210 | 200 | 205 | 580 |
| conc./ppm | | | | |
| NV | 20 | 20 | 20 | 20 |
| solid/% | | | | |
| Throwing | G | G | G | P |
| power | | | | |
| Corrosion | G | G | G | G |
| resist. | | | | |
| Smooth- | G | G | G | G |
| ness | | | | |
| Stability | G | G | G | G |

### EXAMPLE D

### Preparation Example D1

### Preparation of Amine-modified Epoxy Resin

92 parts of 2,4-/2,6-tolylenediisocyanate (weight ratio=8/2), 95 parts of methyl isobutyl ketone (hereinafter, referred to as MIBK) and 0.5 part of dibutyltin dilaurate were loaded to a flask equipped with a stirrer, a cooling tube, a nitrogen introducing tube, a thermometer and a dropping funnel. 21 parts of methanol was added while stirring the mixture.

Starting at room temperature, the reaction mixture was allowed to rise to 60° C. by exothermic, the reaction was retained for 30 minutes, and 57 parts of ethylene glycol mono-2-ethylhexyl ether was dropped from the dropping funnel. Furthermore, 42 parts of bisphenol A-propylene oxide 5 mol adduct was added. The reaction was carried out mainly in the temperature range of 60 to 65° C., and continued until absorption based on an isocyanate group disappeared in IR spectrum measurement.

Next, 365 parts of bisphenol A type epoxy resin of epoxy equivalent 188 synthesized from bisphenol A and epichlorohydrin in accordance with a known method was added to the reaction mixture and heated to 125° C. After that, 1.0 part of benzyldimetylamine was added and allowed to react at 130° C. until epoxy equivalent became 410.

Subsequently, 61 parts of bisphenol A, and 33 parts of octylic acid was added and allowed to react at 120° C. to achieve epoxy equivalent of 1190. Thereafter, the reaction mixture was cooled, and 11 parts of diethanolamine, 24 parts of N-ethylethanolamine and 25 parts of 79% solution in MIBK of ketimined aminoethyl ethanolamine were added, and was allowed to react for 2 hours at 110° C. Then, the reaction mixture was diluted with MIBK until NV solid became 80%, and an amino-modified epoxy resin which has a Tg of 8° C. (solid content: 80%) was obtained.

### Preparation Example D2

### Preparation of Amine-modified Epoxy Resin

An amino-modified epoxy resin which has a Tg of 15° C. (solid content: 80%) was obtained according to substantially the same manner as described in Preparation example D1 except that 74 parts of bisphenol A, and 17 parts of octylic acid were employed.

### Preparation Example D3

### Preparation of Block Polyisocyanate Curing Agent

A block polyisocyanate curing agent was prepared according to substantially the same manner as described in Preparation example A2.

### Preparation Example D4

### Preparation of Pigment Dispersing Resin

222.0 parts of isophoronediisocyanate (hereinafter, referred to as IPDI) was loaded in a reaction vessel equipped with a stirrer, a cooling tube, a nitrogen introducing tube and a thermometer, and after diluted with 39.1 parts of MIBK, 0.2 part of dibutyltin laurate was added. Then, the reaction mixture was heated to 50° C., and 131.5 parts of 2-ethyl hexanol was dropped under dry nitrogen atmosphere over 2 hours with stirring. Reaction temperature was kept at 50° C. by cooling as necessary. As a result of this, 2-ethyl hexanol half blocked IPDI (solid content: 90%) was obtained.

87.2 parts of dimethylethanolamine, 117.6 parts of 75% aqueous solution of lactic acid, and 39.2 parts of ethylene glycol monobutyl ether were added to a suitable reaction vessel, the reaction mixture was stirred at 65° C. for half an hour to prepare a quaternarizing agent.

Subsequently 710.0 parts of EPON 829 (bisphenol A type epoxy resin manufactured by Shell Chemical Company, epoxy equivalents 193 to 203), and 289.6 parts of bisphenol A were loaded to a reaction vessel. The reaction mixture was heated to 150 to 160° C. under nitrogen atmosphere, exothermic reaction was initially occurred. Heating was continued at 150 to 160° C. for about 1 hour, the reaction mixture was then cooled to 120° C., 498.8 parts of the prepared 2-ethyl hexanol half-blocked IPDI (MIBK solution) was added.

The reaction mixture was held at 110 to 120° C. for 1 hour, 463.4 parts of ethylene glycol monobutyl ether were added, the mixture was cooled to 85 to 90° C., homogenized, and 196.7 parts of the prepared quaternarizing agent was added thereto. The reaction mixture was held at 85 to 90° C. until the acid value became 1, 964 parts of deionized water were added to finalize quaternarization of an epoxy-bisphenol A resin and to obtain a pigment dispersing resin having quaternary ammonium moiety (solid content: 50%).

### Preparation Example D5

### Preparation of Pigment Dispersion Paste

120 parts of the pigment dispersing resin obtained in Preparation example D4, 2.0 parts of carbon black, 100.0 parts of kaolin, 80.0 parts of titanium dioxide, 18.0 parts of aluminum phosphomolibudate and 221.7 parts of ion-exchange water were loaded into a sand grinding mill, and they were dispersed until grain size was not more than 10 um, to obtain a pigment dispersion paste (solid content: 48%).

### EXAMPLE D1

### Preparation of Electrodeposition Coating Composition

The amine-modified epoxy resin obtained in Preparation example D1 and the block polyisocyanate curing agent obtained in Preparation example D3 were uniformly mixed in solid content ratio of 70:30. Ethylene glycol 2-ethylhexyl ether was then added so that the amount based on solid content was 3%, and glacial acetic acid was added so that milligram equivalent value of acid based on 100 g of the binder resin solid content MEQ(A) was 30, and ion-exchanged water was slowly added for dilution. MIBK was removed under reduced pressure to obtain an emulsion having a solid content of 36%.

1500 parts of this emulsion, 540 parts of the pigment dispersion paste obtained in Preparation example D6, 1920 parts of ion-exchanged water, 40 parts of 10% cerium acetate aqueous solution, and 10 parts of dibutyltin oxide were mixed, and a cationic electrodeposition coating composition having a solid content of 20.0% was obtained. This electrodeposition coating composition had a volatile organic content in the coating composition (VOC) of 0.9%, a milligram equivalent value of acid based on 100 g of the binder resin solid content (MEQ(A)) of 24.7, and a total concentration of the eluted cerium ion and zinc ion of 390 ppm. Minimum film-forming temperature (MFT) of the electrodeposition coated film deposited therefrom was measured and found to be 22° C.

### EXAMPLE D2

### Preparation of Electrodeposition Coating Composition

The amine-modified epoxy resin obtained in Preparation example D2 and the block polyisocyanate curing agent obtained in Preparation example D3 were uniformly mixed in solid content ratio of 70:30. Glacial acetic acid was added to this so that milligram equivalent value of acid based on 100 g of the binder resin solid content MEQ(A) was 27, and ion-exchanged water was slowly added for dilution. MIBK was removed under reduced pressure to obtain an emulsion having a solid content of 36%.

1500 parts of this emulsion, 540 parts of the pigment dispersion paste obtained in Preparation example D6, 1940 parts of ion-exchanged water, 20 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.5%, a MEQ(A) of 20.5, a total concentration of the eluted cerium ion and zinc ion of 185 ppm. MFT of this coating composition was measured to be 28° C.

### Comparative Example D

### Preparation of Electrodeposition Coating Composition

The amine-modified epoxy resin obtained in Preparation example D2 and the block polyisocyanate curing agent obtained in Preparation example D4 were uniformly mixed in solid content ratio of 70:30. Ethylene glycol 2-ethylhexyl ether was then added so that the amount based on solid content was 5%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of pigment dispersion paste prepared in Preparation example D6, 1900 parts of ion-exchanged water, 60 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 1.1%, a MEQ(A) of 29.9, and a total concentration of the eluted cerium ion and zinc ion of 590 ppm. MFT of this coating composition was measured to be 19° C.

The electrodeposition coating compositions prepared in Examples and Comparative Examples were evaluated according to the same manner as described in (1) to (4) of Example A.

TABLE D

| | Ex. D1 | Ex. D2 | CEx. D |
|---|---|---|---|
| VOC/% | 0.9 | 0.5 | 1.1 |
| MEQ(A)/ | 24.7 | 20.5 | 29.9 |
| mgeq. | | | |
| Metal ion | 390 | 185 | 590 |
| conc./ppm | | | |
| MFT/° C. | 22 | 28 | 19 |
| Throwing | G | G | P |
| power | | | |
| Corrosion | G | G | G |
| resist. | | | |
| Smooth- | G | G | G |
| ness | | | |
| Stability | G | G | G |

### EXAMPLE E

### Preparation Example E1

### Preparation of Amine-modified Epoxy Resin

An amine-modified epoxy resin was prepared according to substantially the same manner as described in Preparation example C1.

### Preparation Example E2

### Preparation of Amine-modified Epoxy Resin

An amine-modified epoxy resin was prepared according to substantially the same manner as described in Preparation example C2.

### Preparation Example E3

### Preparation of Block Polyisocyanate Curing Agent

A block polyisocyanate curing agent was prepared according to substantially the same manner as described in Preparation example A2. The block polyisocyanate curing agent had a Tg of 0° C.

### Preparation Example E4

### Preparation of Pigment Dispersing Resin

A pigment dispersing resin was prepared according to substantially the same manner as described in Preparation example C4.

### Preparation Example E5

### Preparation of Pigment Dispersion Paste

A pigment dispersion paste was prepared according to substantially the same manner as described in Preparation example C5.

### EXAMPLE E1

### Preparation of Electrodeposition Coating Composition

The amine-modified epoxy resins obtained in Preparation examples E1 and E2, and the block polyisocyanate curing agent obtained in Preparation example E3 were uniformly mixed in solid content ratio of 20:50:30. Glacial acetic acid was added to this so that milligram equivalent value of acid based on 100 g of the binder resin solid content MEQ(A) was 30, and ion-exchanged water was slowly added for dilution. MIBK was removed under reduced pressure to obtain an emulsion having a solid content of 36%.

1500 parts of this emulsion, 540 parts of the pigment dispersing resin obtained in Preparation example E5, 1920 parts of ion-exchanged water, 40 parts of 10% cerium acetate aqueous solution, and 10 parts of dibutyltin oxide were mixed, and a cationic electrodeposition coating composition having a solid content of 20.0% was obtained. This electrodeposition coating composition had a volatile organic content in the coating composition (VOC) of 0.5%, a milligram equivalent value of acid based on 100 g of the binder resin solid content (MEQ(A)) of 24.2, and a total concentration of the eluted cerium ion and zinc ion of 390 ppm. Tg of the electrodeposition coated film deposited therefrom (uncured) was calculated from the Tgs of the respective component resins and found to be 10° C. In conducting electrodeposition coating, the electrodeposition bath was regulated at a temperature of 30° C.

### EXAMPLE E2

### Preparation of Electrodeposition Coating Composition

The amine-modified epoxy resin obtained in Preparation example E2 and the block polyisocyanate curing agent obtained in Preparation example E3 were uniformly mixed in solid content ratio of 70:30. Glacial acetic acid was added to this so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of the pigment dispersing resin obtained in Preparation example E5, 1940 parts of ion-exchanged water, 20 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.5%, a MEQ(A) of 25.5, a total concentration of the eluted cerium ion and zinc ion of 205 ppm. Tg of the electrodeposition coated film deposited therefrom (uncured) was calculated to be 14° C. In conducting electrodeposition coating, the electrodeposition bath was regulated at a temperature of 28° C.

### Comparative Example E1

### Preparation of Electrodeposition Coating Composition

The amine-modified epoxy resins obtained in Preparation examples E1 and E2, and the block polyisocyanate curing agent obtained in Preparation example E3 were uniformly mixed in solid content ratio of 40:30:30. Ethylene glycol 2-ethylhexyl ether was then added so that the amount based on solid content was 3%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of pigment dispersion paste prepared in Preparation example E5, 1900 parts of ion-exchanged water, 60 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.9%, a MEQ(A) of 31.1, and a total concentration of the eluted cerium ion and zinc ion of 590 ppm. Tg of the electrodeposition coated film deposited therefrom (uncured) was calculated to be 7° C. In conducting electrodeposition coating, the electrodeposition bath was regulated at a temperature of 30° C.

### Comparative Example E2

### Preparation of Electrodeposition Coating Composition

The amine-modified epoxy resin obtained in Preparation example E1, and the block polyisocyanate curing agent obtained in Preparation example E3 were uniformly mixed in solid content ratio of 70:30. Ethylene glycol 2-ethylhexyl ether was then added so that the amount based on solid content was 3%, and glacial acetic acid was added so that milligram equivalent value of acid based on 100 g of the binder resin solid content MEQ(A) was 30, and ion-exchanged water was slowly added for dilution. MIBK was removed under reduced pressure to obtain an emulsion having a solid content of 36%.

1500 parts of this emulsion, 540 parts of pigment dispersion paste prepared in Preparation example E5, 1920 parts of ion-exchanged water, 40 parts of 10% cerium acetate aqueous solution, and 10 parts of dibutyltin oxide were mixed, and a cationic electrodeposition coating composition having a solid content of 20.0% was obtained. This electrodeposition coating composition had a VOC of 0.9%, a MEQ(A) of 25.7, and a total concentration of the eluted cerium ion and zinc ion of 400 ppm. Tg of the electrodeposition coated film deposited therefrom (uncured) was calculated to be 1.5° C. In conducting electrodeposition coating, the electrodeposition bath was regulated at a temperature of 33° C.

The electrodeposition coating compositions prepared in Examples and Comparative Examples were evaluated according to the same manner as described in (1) to (4) of Example A.

TABLE E

| | Ex. E1 | Ex. E2 | CEx. E1 | CEx. E2 |
|---|---|---|---|---|
| (a) Film | 10 | 14 | 7 | 1.5 |
| Tg/° C. | | | | |
| (b) Bath | 30 | 28 | 30 | 33 |
| temp/° C. | | | | |
| (b) − (a) | 20 | 14 | 23 | 31.5 |
| VOC/% | 0.5 | 0.5 | 0.9 | 0.9 |
| MEQ(A)/ | 24.2 | 25.5 | 31.1 | 25.7 |
| mgeq. | | | | |
| Metal ion | 390 | 205 | 590 | 400 |
| conc./ppm | | | | |
| NV | 20 | 20 | 20 | 20 |
| solid/% | | | | |
| Throwing | G | G | P | P |
| power | | | | |
| Corrosion | G | G | G | G |
| resist. | | | | |
| Smooth- | G | G | G | G |
| ness | | | | |
| Stability | G | G | G | G |

### EXAMPLE F

### Preparation Example F1

### Preparation of Amine-modified Epoxy Resin

An amine-modified epoxy resin was prepared according to substantially the same manner as described in Preparation example A1.

### Preparation Example F2

### Preparation of Block Polyisocyanate Curing Agent

A block polyisocyanate curing agent was prepared according to substantially the same manner as described in Preparation example A2.

### Preparation Example F3

### Preparation of Pigment Dispersing Resin

A pigment dispersing resin was prepared according to substantially the same manner as described in Preparation example A3.

### Preparation Example F4

### Preparation of Pigment Dispersion Paste

A pigment dispersion paste was prepared according to substantially the same manner as described in Preparation example A4.

### Preparation Example F5

### Preparation of Electrodeposition Coating Composition

The amine-modified epoxy resin obtained in Preparation example F1 and the block polyisocyanate curing agent obtained in Preparation example F2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 21, and ion-exchanged water was slowly added for dilution. MIBK was removed under reduced pressure to obtain an emulsion having a solid content of 36%.

2220 parts of this emulsion, 1740 parts of ion-exchanged water, 40 parts of 10% cerium acetate aqueous solution, and 16 parts of dibutyltin oxide were mixed, and a cationic electrodeposition coating composition having a solid content of 20.0% was obtained. This electrodeposition coating composition had no pigment, a volatile organic content in the coating composition (VOC) of 0.4%, a milligram equivalent value of acid based on 100 g of the binder resin solid content (MEQ(A)) of 25.2, and a total concentration of the eluted cerium ion and zinc ion of 405 ppm.

Throwing power of the resulting electrodeposition coating composition was evaluated according to the Ford pipe method as described in (1) of Example A. The result was shown in Table F.

### Preparation Example F6

### Preparation of Electrodeposition Coating Composition

The amine-modified epoxy resin obtained in Preparation example F1 and the block polyisocyanate curing agent obtained in Preparation example F2 were uniformly mixed in solid content ratio of 70:30. Ethylene glycol 2-ethylhexyl ether was then added so that the amount based on solid content was 2%, and glacial acetic acid was added so that milligram equivalent value of acid based on 100 g of the binder resin solid content MEQ(A) was 18, and ion-exchanged water was slowly added for dilution. MIBK was removed under reduced pressure to obtain an emulsion having a solid content of 36%.

2220 parts of this emulsion, 1760 parts of ion-exchanged water, 20 parts of 10% cerium acetate aqueous solution, and 16 parts of dibutyltin oxide were mixed, and a cationic electrodeposition coating composition having a solid content of 20.0% was obtained. This electrodeposition coating composition had no pigment, a VOC of 0.4%, a MEQ(A) of 20.1, and a total concentration of the eluted cerium ion and zinc ion of 205 ppm.

Throwing power of the resulting electrodeposition coating composition was evaluated according to the Ford pipe method as described in (1) of Example A. The result was shown in Table F.

### Comparative Preparation Example F

### Preparation of Electrodeposition Coating Composition

The amine-modified epoxy resin obtained in Preparation example F1 and the block polyisocyanate curing agent obtained in Preparation example F2 were uniformly mixed in solid content ratio of 70:30. Ethylene glycol 2-ethylhexyl ether was then added so that the amount based on solid content was 1%, and glacial acetic acid was added so that milligram equivalent value of acid based on 100 g of the binder resin solid content MEQ(A) was 35, and ion-exchanged water was slowly added for dilution. MIBK was removed under reduced pressure to obtain an emulsion having a solid content of 36%.

1500 parts of this emulsion, 540 parts of the pigment dispersion paste prepared in Preparation example F4, 1900 parts of ion-exchanged water, 60 parts of 10% cerium acetate aqueous solution, and 10 parts of dibutyltin oxide were mixed, and a cationic electrodeposition coating composition having a solid content of 20.0% was obtained. This electrodeposition coating composition had a solid content ratio by weight between the pigment and the total resin (P/V) of 1/3, a VOC of 1.5%, a MEQ(A) of 30.3, and a total concentration of the eluted cerium ion and zinc ion of 610 ppm.

Throwing power of the resulting electrodeposition coating composition was evaluated according to the Ford pipe method as described in (1) of Example A. The result was shown in Table F.

### EXAMPLE F1

The electrodeposition coating composition obtained in Preparation example F5 was filled in a stainless steel vessel and this was used as an electrodeposition bath. A cold rolled steel plate (JIS G3141 SPCC-SD) which had been treated with zinc phosphate treating agent SURFDINE SD-50 available from Nippon Paint K.K, was dipped in the electrodeposition bath, and an electric current was passed with using the steel plate as a cathode so that the resulting electrodeposition coated film had a thickness in dry state of 20 um. Thereafter, the coated steel plate was took up from the electrodeposition bath, and washed with water.

Drops of water on the electrodeposition coated surface were brown off, and a melamine cure type polyester resin solvent based intermediate coating composition “ORGA P-2” available from Nippon Paint K.K. (curing temperature: 110° C.) was applied by an air spray method on the uncured electrodeposition coated surface. The splay coating was conducted at 23° C. so that the resulting intermediate coated film had a thickness in dry state of 40 um. Thereby a coated steel plate having thereon an electrodeposition coated film and an intermediate coated film was obtained.

The coated steel plate was subjected to setting for 5 minutes, and placed in an oven regulated at 160° C. for 20 minutes to obtain a cured double layered coated film. A surface of the intermediate coated film was tested in smoothness by measuring SW value using the WAVESCAN manufactured by Big Chemie Co., Ltd. The small SW value means good surface smoothness. Evaluation was made according to the following criteria.

Good: not more than 30 of SW

Poor: more than 30 of SW

### EXAMPLE F2

A double layered coated film was prepared and evaluated according to substantially the same manner as described in Example F 1, except that the electrodeposition coating composition obtained in Preparation example FG was employed. The results were shown in Table F.

### Comparative Example F

A double layered coated film was prepared and evaluated according to substantially the same manner as described in Example F1, except that the electrodeposition coating composition obtained in Comparative preparation example F was employed. The results were shown in Table F.

TABLE F

| Coating | | | |
|---|---|---|---|
| Composition | PEx. F5 | PEx. F6 | CPEx. F |
| VOC/% | 0.4 | 0.4 | 1.5 |
| MEQ(A)/ | 25.2 | 20.1 | 30.3 |
| mgeq. | | | |
| Metal ion | 405 | 205 | 610 |
| conc./ppm | | | |
| P/V | 0 | 0 | 1/3 |
| Throwing | G | G | P |
| power | | | |
| Coated Film | Ex. F1 | Ex. F2 | CEx. F |
| Smoothness | G | G | P |
| SW value | 35 | 33 | 40 |

What is claimed is:

1. A lead-free cationic electrodeposition coating composition which comprises an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst,
wherein the electrodeposition coating composition has a volatile organic content of 1% by weight or less, a metal ion content of 500 ppm or less, a neutralizing acid amount of 10 to 30 mg equivalent based on 100 g of binder resin solid content.

2. The lead-free cationic electrodeposition coating composition according to claim 1, wherein the metal ion is one or more selected from the group consisting of cerium ion, bismuth ion, copper ion, zinc ion, molybdenum ion, and aluminium ion.

3. The lead-free cationic electrodeposition coating composition according to claim 1, wherein the neutralizing acid is one or more selected from the group consisting of acetic acid, lactic acid, formic acid, and sulfamic acid.

4. The lead-free cationic electrodeposition coating composition according to claim 1 which further comprises a pigment in a ratio of 1/9 or less by weight based on a resin solid contained in the coating composition.

5. The lead-free cationic electrodeposition coating composition according to claim 1 which has a nonvolatile content of 22 to 35% by weight.

6. The lead-free cationic electrodeposition coating composition according to claim 5, wherein the metal ion is one or more selected from the group consisting of cerium ion, bismuth ion, copper ion, zinc ion, molybdenum ion, and aluminium ion.

7. The lead-free cationic electrodeposition coating composition according to claim 5, wherein the neutralizing acid is one or more selected from the group consisting of acetic acid, lactic acid, formic acid, and sulfamic acid.

8. The lead-free cationic electrodeposition coating composition according to claim 1 which provides an electrodeposition coated film having a glass transition temperature of 5 to 20° C.

9. The lead-free cationic electrodeposition coating composition according to claim 8, wherein the cationic epoxy resin is an oxazolidone ring-containing amine modified epoxy resin.

10. The lead-free cationic electrodeposition coating composition according to claim 8, wherein the metal ion is one or more selected from the group consisting of cerium ion, bismuth ion, copper ion, zinc ion, molybdenum ion, and aluminium ion.

11. The lead-free cationic electrodeposition coating composition according to claim 8, wherein the neutralizing acid is one or more selected from the group consisting of acetic acid, lactic acid, formic acid, and sulfamic acid.

12. The lead-free cationic electrodeposition coating composition according to claim 1 which provides an electrodeposition coated film having a minimum film-forming temperature of 20 to 35° C.

13. The lead-free cationic electrodeposition coating composition according to claim 12, wherein the cationic epoxy resin is an oxazolidone ring-containing amine modified epoxy resin.

14. The lead-free cationic electrodeposition coating composition according to claim 12, wherein the metal ion is one or more selected from the group consisting of cerium ion, bismuth ion, copper ion, zinc ion, molybdenum ion, and aluminium ion.

15. The lead-free cationic electrodeposition coating composition according to claim 12, wherein the neutralizing acid is one or more selected from the group consisting of acetic acid, lactic acid, formic acid, and sulfamic acid.

16. An electrodeposition coating process comprising the steps of:
filling an electrodeposition bath with a lead-free cationic electrodeposition coating composition which comprises an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst, and which has a volatile organic content of 1% by weight or less, a metal ion content of 500 ppm or less, a neutralizing acid amount of 10 to 30 mg equivalent based on 100 g of binder resin solid content;
regulating temperature of the electrodeposition bath between the range of from the glass transition temperature of an electrodeposition coated film up to 30° C. above the glass transition temperature with the proviso that the lowest temperature is 10° C., and the highest temperature is 60° C.;
dipping a substrate to be coated in the electrodeposition coating composition; and
conducting electrodeposition coating with using the substrate as a cathode at the regulated temperature condition of electrodeposition bath to form a coated film on a surface of the substrate.

17. The electrodeposition coating process according to claim 16, wherein the electrodeposition bath has a temperature of 25 to 35° C.

18. The electrodeposition coating process according to claim 16, wherein the coated film formed by electrodeposition coating on the substrate has a glass transition temperature of 5 to 20° C.

19. The electrodeposition coating process according to claim 16, wherein the metal ion of the lead-free cationic electrodeposition coating composition is one or more selected from the group consisting of cerium ion, bismuth ion, copper ion, zinc ion, molybdenum ion, and aluminium ion.

20. The electrodeposition coating process according to claim 16, wherein the neutralizing acid of the lead-free cationic electrodeposition coating composition is one or more selected from the group consisting of acetic acid, lactic acid, formic acid, and sulfamic acid.

21. A process for forming a double layered coated film comprising the steps of: conducting an electrodeposition coating method with using an electrodeposition coating composition to form an uncured electrodeposition coated film on a surface of a substrate to be coated; coating an intermediate coating composition on the electrodeposition coated film to form an uncured intermediate coated film; and baking the electrodeposition coated film and the intermediate coated film to cure simultaneously,
wherein the electrodeposition coating composition is a lead-free cationic electrodeposition coating composition which comprises an aqueous medium, a binder resin composed of a cationic epoxy resin and a blocked isocyanate curing agent dispersed or dissolved in the aqueous medium, a neutralizing acid in order to neutralize the cationic epoxy resin, an organic solvent, and a metal catalyst, and which has a volatile organic content of 1% by weight or less, a metal ion content of 500 ppm or less, a neutralizing acid amount of 10 to 30 mg equivalent based on 100 g of binder resin solid content.

22. The process for forming a double layered coated film according to claim 21, wherein the metal ion of the lead-free cationic electrodeposition coating composition is one or more selected from the group consisting of cerium ion, bismuth ion, copper ion, zinc ion, molybdenum ion, and aluminium ion.

23. The process for forming a double layered coated film according to claim 21, wherein the neutralizing acid of the lead-free cationic electrodeposition coating composition is one or more selected from the group consisting of acetic acid, lactic acid, formic acid, and sulfamic acid.

24. The process for forming a double layered coated film according to claim 21, wherein the lead-free cationic electrodeposition coating composition further comprises a pigment in a ratio of 1/9 or less by weight based on a resin solid contained in the coating composition.

25. The process for forming a double layered coated film according to claim 21, wherein the intermediate coating composition is the aqueous based form, or the solvent based form.
